(19) United States
(12) Patent Application Publication
(10) Pub. No.: US 2022/0374828 A1
(43) Pub. Date: Nov. 24, 2022

(54) Systems and Methods for Monitoring a Storeroom

(71) Applicant: EXPEDI, INC., HOUSTON, TX (US)

(72) Inventors: Eric Toureilles, Houston, TX (US); Raymond Glasgow, Houston, TX (US); Matthew Hillig, Houston, TX (US)

(21) Appl. No.: 17/752,270

(22) Filed: May 24, 2022

Related U.S. Application Data
(60) Provisional application No. 63/192,514, filed on May 24, 2021.
(60) Provisional application No. 63/225,843, filed on Jul. 26, 2021.
(60) Provisional application No. 63/278,311, filed on Nov. 11, 2021.

(51) Int. Cl. G06Q 10/08; G06K 7/10

(52) U.S. Cl. CPC G06Q 10/087; G06K 7/10475

(57) ABSTRACT

A system for monitoring a storeroom includes at least two radio frequency identification (RFID) readers/antennas that are configured to detect RFID tags attached to items or individuals. The RFID readers/antennas are positioned and configured to sequentially detect an RFID tag attached to an item or an individual as the item or individual moves into or out of a storeroom. The order in which the two RFID readers/antenna detect the RFID tag provide an indication of whether the tagged item or individual is moving into or out of the storeroom. A processing system coupled to the RFID readers/antennas can monitor the movement of goods and individuals into and out of the storeroom and automatically update an inventory of the storeroom based on the determined movements of goods and individuals.

This application claims the benefit of the filing dates of U.S. Provisional Patent Application Nos. 63/192,514, filed May 24, 2021, U.S. Provisional Patent Application No. 63/225,843, filed Jul. 26, 2021, and U.S. Provisional Patent Application No. 63/278,311, filed Nov. 11, 2021, the contents of all of which are incorporated herein by reference.

### BACKGROUND

The present disclosure is directed to radio-frequency identification (RFID) methods and systems for monitoring a storeroom and inventory management.

### BRIEF DESCRIPTION OF THE DRAWINGS

FIGS. 1A and 1B schematically illustrate RFID systems for monitoring a storeroom, according to a first embodiment of the present disclosure;

FIG. 2 schematically illustrates an RFID system for monitoring a storeroom, according to a second embodiment of the present disclosure;

FIG. 3 schematically illustrates an RFID system for monitoring a storeroom, according to a third embodiment of the present disclosure;

FIG. 4 is a flowchart illustrating a first method according to the present disclosure;

FIGS. is a flowchart illustrating a second method according to the present disclosure; and

FIG. 6 is a flowchart illustrating a third method according to the present disclosure.

### DETAILED DESCRIPTION

The systems, methods, and devices of the present disclosure each have several aspects, no single one of which is solely responsible for its desirable attributes. Without limiting the scope of this disclosure as expressed by the claims that follow, some features will now be discussed briefly. After considering this discussion, and particularly after reading this section, one will understand how the features of this disclosure provide advantages that include improved monitoring of items in a storeroom.

The items that are stored in a storeroom could include consumable and non-consumable items, collectively referred to as “items” herein. Consumable items can include things such as lubricants, wear plates, gloves, paper, toner cartridges, cleaners, and fuel. Non-consumable items can include tools, diagnostic equipment, rentals and other maintenance items that are returned back to the storeroom.

It may be helpful or necessary to restrict access to a storeroom to ensure items are not improperly removed and to ensure records regarding the items in the storeroom are kept properly updated. For example, many industrial sites, such as refineries, have storerooms that are managed by one or more individuals that examine the storeroom and its contents on a regular basis to inspect non-consumable items, to determine the quantities of consumable items that have been used, to prepare invoices for items removed from the storeroom and to manage replenishment of the items in the storeroom.

Workers may work more efficiently when they have free access to the consumable and non-consumable items in a storeroom. But allowing free access to these items presents a risk that items may be taken for inappropriate purposes. For these reasons, it is desirable to track both the movement of items into and out of the storeroom, and possibly also the identity of the individuals bringing items into the storeroom and removing items from the storeroom.

In addition to monitoring items in a storeroom for purposes of preventing or tracking inappropriate uses of items, it is desirable to track information about the quantities of consumable supplies so that additional consumable supplies may be purchased before the currently available consumable supplies run out.

In the case of non-consumable items, such as maintenance and rental items, it may be helpful to track how often such non-consumable items are removed from the storeroom, used, and then returned to the storeroom. Information about uses of non-consumable items may be useful in determining when to calibrate tools and diagnostic equipment, and when to schedule and perform maintenance actions.

The present disclosure is directed to systems and methods for monitoring and tracking the items in a storeroom while still allowing workers free access to the items in the storeroom. In the disclosed systems and methods, records of items that are carried into and removed from the storeroom are automatically maintained using radio-frequency identification (RFID) tags and associated RFID readers/antennas.

As used herein, an RFID tag generally refers to a device with an antenna or resonator that can produce a wireless signal when activated or powered. The wireless signal produced by the RFID tag is typically low power and intended for transmission over short distances. The RFID tag may be formed of any material and may be flexible or rigid. In some implementations, the RFID tag may include an adhesive on a portion of the exterior of an RFID tag surface to enable attachment of the tag to an item, such as an inventory item.

An RFID tag may be an active RFID tag in which the RFID tag includes an internal power supply (e.g., a battery), a passive RFID tag in which the RFID tag does not include a power supply and is activated by power supplied by an RFID reader/antenna, a battery-assisted RFID tag in which the RFID tag includes a power supply (battery) but is activated by power supplied by an RFID reader/antenna, an active near field communication (“NFC”) tag, a passive NFC tag, a Bluetooth tag, or any other type of tag that can be configured to provide an identifier over a radio frequency. Likewise, an RFID reader/antenna, as used herein, refers to any type of RFID reader/antenna that can communicate with, interrogate and/or receive information from an RFID tag.

When an RFID tag is assigned to or attached to an item, a relationship between the particular RFID tag and the corresponding item is recorded in a database of items. When the RFID tag is detected by an RFID reader/antenna, the signal from the RFID tag may be read to identify the particular RFID tag. The database can then be consulted to identify the corresponding item to which the RFID tag is attached. Similarly, when an RFID tag is assigned to a person, a relationship between the particular RFID tag and the corresponding person is recorded in a database. When the RFID tag is detected by an RFID reader/antenna, the particular RFID tag may be identified. The database can then be consulted to identify the person associated with the identified RFID tag.

A “storeroom,” as used herein, refers to any container with walls and an opening that may be used for storing items. For example, a storeroom may be a room or a space in a warehouse or other building, a trailer, a portable container, or a shed. As used herein, a “doorway” of a storeroom may be any opening, portal, or access point through which items may be removed from the storeroom. Such a doorway may or may not have a door.

As noted above, RFID tags are attached to one or more items that are to be placed in a storeroom. One or more RFID tag readers are located at or adjacent to a doorway of the storeroom. As each item is brought into the storeroom, one or more RFID tag readers detect the RFID tag on the item, and an inventory of the storeroom is updated to reflect the addition of the item to the storeroom. Likewise, when an item is removed from the storeroom, one or more RFID readers/antennas detect the RFID tag attached to the item, and the inventory is updated to reflect the removal of the item from the storeroom.

In some instances, individuals that bring items into the storeroom and that remove items from the storeroom may carry their own RFID tag, such as an RFID tag that is attached to an individual's ID card or apparel. In these circumstances, when an individual brings an item into the storeroom, one or more RFID tag readers/antennas could detect both the RFID tag attached to the item and the RFID tag of the individual bringing the item into the storeroom. As a result, the inventory may be updated to reflect both that the item has been added to the storeroom, and the identity of the individual that brought the item into the storeroom. Likewise, when an individual removes an item from the storeroom, one or more RFID tag readers/antennas may detect both the RFID tag attached to the item and the RFID tag associated with the individual, and the inventory can be updated to reflect both the removal of the item from the storeroom and the identity of the individual that removed the item from the storeroom.

In instances where the RFID tag readers/antennas are configured to read the RFID tags of individuals bringing items into the storeroom and removing items from the storeroom, the control system may be configured to issue an error report if the RFID tag readers/antennas detect a RFID tag of an item entering or leaving the storeroom, but not an RFID tag of an individual that is carrying the item into or out of the storeroom.

In some systems and methods as disclosed in the present application, a storeroom has only a single doorway through which all items and individuals must pass. In alternate embodiments, a storeroom may have multiple doorways. Regardless, RFID readers/antennas are installed at or adjacent to a doorway and are configured to detect any RFID tags that pass through the doorway. In preferred embodiments, two RFID readers/antennas are positioned in or adjacent the doorway such that an RFID tag on an item or individual moving into the storeroom will be detected first by a first RFID reader/antenna, and then subsequently will be detected by the second RFID reader/antenna. In the same fashion, an RFID tag moving out of the storeroom will be detected first by the second RFID reader/antenna, and then subsequently by the first RFID reader/antenna. By noting the timing at which each RFID reader/antenna reports detection of the RFID tag, one can determine whether the RFID tag is passing into or out of the storeroom.

Because the first and second RFID readers/antennas are both positioned in or adjacent to the doorway of the storeroom, it is necessary to position and/or configure the first and second RFID readers/antennas so that they do not simultaneously detect an RFID tag, which would make it impossible to discern whether the RFID tag is passing into or out of the storeroom. This can be accomplished by properly aiming the first and second RFID readers/antennas such that the areas over which they detect RFID tags do not substantially overlap. It can also be helpful to configure the detection sensitivity of the RFID readers/antennas such that the distance over which they detect RFID tags is sufficiently short that substantial overlap of the detection areas does not occur.

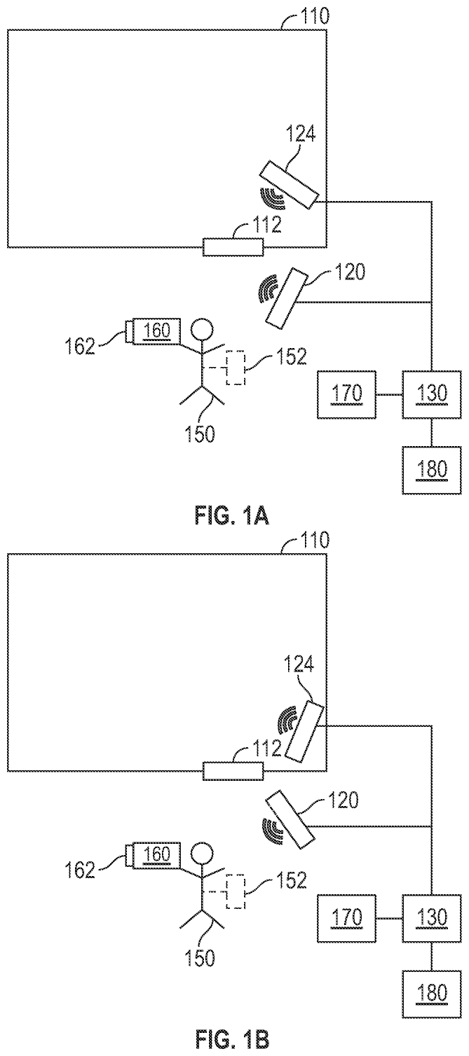

A first embodiment of a system for monitoring a storeroom is illustrated in FIG. 1A. As shown therein, a first RFID reader/antenna 120 is positioned just outside of a doorway 112 of the storeroom 110. A second RFID reader/antenna 124 is positioned just inside the doorway 112. The spatial separation between the first RFID reader/antenna 120 and the second RFID reader/antenna 124 help to prevent interference between the two RFID readers/antennas 120/124 and help to prevent the two RFID readers/antennas 120/124 from simultaneously detecting the same RFID tag. The directions in which the two RFID readers/antennas 120/124 are aimed can also help to prevent the two RFID readers/antennas 120/124 from simultaneously detecting the same RFID tag.

When an individual 150 carries an item 160 to which an RFID tag 162 is attached into the storeroom 110, the first RFID reader/antenna 120 will detect the RFID tag 162 before the second RFID reader/antenna 124 detects the RFID tag 162. Conversely, if the individual 150 removes the item 160 from the storeroom 110, the second RFID reader/antenna 124 will detect the RFID tag 162 before the first RFID reader/antenna 120 detects the RFID tag 162 attached to the item 160. Thus, the timing of when each of the first and second RFID readers/antennas 120/124 detect the RFID tag 162 can be used to determine if the item 160 is being brought into or removed from the storeroom 110.

As noted above, an RFID tag 152 may be associated with and carried by the individual 150 that is bringing an item 160 into the storeroom 110 or who is removing an item 160 from the storeroom 110. If the first RFID reader/antenna 120 detects both the RFID tag 162 attached to the item 160 and the RFID tag 152 associated with the individual 150 at approximately the same time, and before the second RFID reader/antenna 124 detects the RFID tags 162, 152, the monitoring system is able to determine and record the fact that the item 160 has been brought into the storeroom, and the identity of the individual that brought the item into the storeroom. Likewise, if the second RFID reader/antenna 124 detects both the RFID tag 162 attached to the item 160 and the RFID tag 152 associated with the individual 150 at approximately the same time, and before the first RFID reader/antenna 120 detects the RFID tags 162/152, the monitoring system is able to determine both the fact that the item 160 has been removed from the storeroom, and the identity of the individual that removed the item 160 from the storeroom.

In instances where the exterior of the storeroom 110 is exposed to the elements and weather, the first RFID reader/antenna 120 mounted outside the storeroom 110 may be specifically configured to be weather resistant.

As illustrated in FIG. 1A, the first and second RFID readers/antennas 120/124 are coupled to a processing system 130 that can include one or more processors. The first and/or second RFID readers/antennas 120/124 can be hard wired to one or more processing systems 130, or they could be coupled to one or more processing systems 130 via any sort of wireless means, such as via a BlueTooth connection, a wireless computer network such as a WiFi or WiMax, or a cellular telephony link. In that event, one or both of the first and second RFID readers/antennas 120/124 may incorporate a wireless transmitter or transceiver that enable the RFID readers/antenna 120/124 to communicate wirelessly. In some embodiments, multiple individual RFID readers/antenna may share a single wireless transmitter or transceiver.

In some instances, the first and/or second RFID readers/antennas 120/124 could be coupled to a local or public computer network, such as the Internet, via wired or wireless means, and the RFID readers/antennas 120/124 could communicate with one or more processing systems 130 via that local or public computer network. Also, the way in which the first RFID antenna/reader 120 communicates with one or more processing systems can differ from the way in which the second RFID reader/antenna 124 communicates with the one or more processing systems.

As used herein, a “processing system” refers to one or more computers, including both their hardware and software, used to implement and/or perform the various steps and operations described herein. When two or more computers are used as a processing system 130, the networking peripherals the computers use in communicating with each other are included in the processing system 130.

The processing system 130 may be configured to receive signals from the first and second RFID readers/antennas 120/124 each time that one of the RFID readers/antennas 120/124 detects an RFID tag. Alternatively, the processing system may periodically poll the first and second RFID readers/antennas 120/124 to obtain information about any RFID tags that were recently detected by the first and second RFID readers/antennas 120/124. That information could include the identity of the detected RFID tags and the times at which the RFID readers/antennas detected each RFID tag. Likewise, the RFID readers/antennas 120/124 may be configured to periodically send information about detected RFID tags to the processing system 130.

The processing system 130 is coupled to an alarm system 170 that can generate various types of alarms and/or alerts when potentially improper actions are detected by the processing system 130. For example, the alarm system 170 may be configured to generate an audio and/or optical signal when the processing system 130 determines that an improper action may have occurred. The alarm system 170 may also be configured to generate and send one or more alert messages to monitoring personnel when a potentially improper action is detected. Those alert messages could take the form of email messages, text messages, push notifications, audio or video telephone calls, or other forms of alert messages.

The processing system 130 is also coupled to an inventory control system 180 that tracks the items being placed into and removed from the storeroom 110. The inventory control system 180 may be configured to record and track the type, quantity, condition, cost, location, assigned RFID tags 162, or any other suitable parameters of items that are placed in a storeroom. The inventory control system 180 may be configured to report on the current inventory in the storeroom 110 and to provide information about the current inventory in response to inquiries.

The inventory control system 180 may also be designed to automatically order new supplies when the supplies of certain items becomes lower than a threshold value. The inventory control system 180 may also be configured to send work orders for maintenance or calibration of items in a storeroom according to usage records of the items. The inventory control system 180 may further include one or more databases relating to employees and their authorizations to use or remove items stored in the storeroom 110.

The processing system 130 may be connected to the first and second RFID readers/antennas 120/124, the alarm system 170 and the inventory control system 180 via hardwires, optical fibers, a wired or wireless computer network (e.g., Ethernet or an internet protocol (IP) network), or via a wireless communication system such as Bluetooth, Wifi or a cellular telephony system.

The first and second RFID readers/antennas 120/124 may be mounted adjacent to and aimed at the doorway 112 to thereby monitor items moving through the doorway 112. One or both of the first and second RFID readers/antennas 120/124 may also be mounted within the doorway 112 itself, such as in the doorframe. In still other instances, one or both of the first and second RFID readers/antennas 120/124 may be mounted in the floor or ceiling of the storeroom 110.

The first RFID reader/antenna 120 may be configured and/or aimed so as to not monitor the interior of the storeroom and/or be configured to have a detection range that is so short that the first RFID reader/antenna 120 is unable to detect RFID tags that are inside the storeroom. Similarly, the second RFID 124 reader/antenna may be configured and/or aimed so as to not monitor the exterior of the storeroom and/or be configured to have a detection range that is so short that the second RFID reader/antenna 124 is unable to detect RFID tags that are outside the storeroom.

FIG. 1B shows a system similar to the one illustrated in FIG. 1A, but with the first and second RFID readers/antennas 120/124 aimed differently. The inventors have discovered that when the RFID readers/antennas 120/124 are positioned as illustrated in FIG. 1A, and when the door or doorway 112 are made of metal, the signals from the first RFID reader/antenna 120 may be reflected off of the door or doorway 112 into the interior of the storeroom 110. Likewise, the signal from the second RDIF reader/antenna 124 may be reflected outside the storeroom 110. In either case, this can lead to errors or problems in detecting whether an RFID tag 162 and an associated item are moving into or out of the storeroom 110.

In the embodiment illustrated in FIG. 1B, the first and second RFID readers/antennas 120/124 are positioned differently to help prevent the signals from the first RFID reader/antenna from being reflected into the storeroom 110 and to help prevent the signal from the second RFID reader/antenna 124 from being reflected outside the storeroom 110. This helps to prevent errors in detecting movements of RFID tags 162 and associated items 160 into and out of the storeroom. Of course, the depiction in FIG. 1B is only an example. The first and second RFID readers/antennas 120/124 could be aimed or positioned in alternate ways to achieve this same result. For example, to help eliminate detection errors it also may be helpful to position the first and second RFID readers/antennas 120/124 on the ceiling aiming downward or on the floor pointing upward. Similarly, one of the first and second RFID readers/antennas 120/124 could be mounted near the floor pointing upward and the other of the first and second RFID readers/antennas 120/124 could be positioned on the ceiling pointing downward.

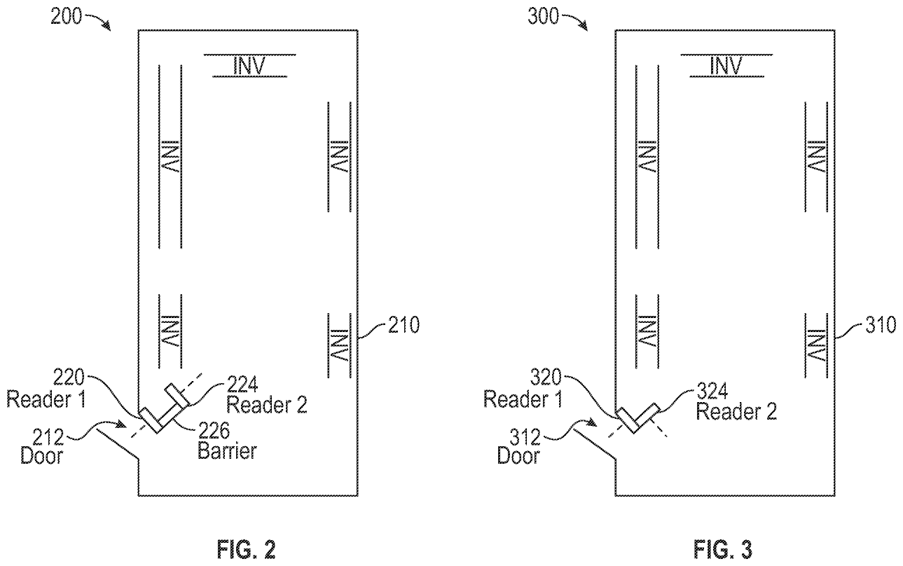

FIG. 2 depicts an alternate arrangement of the elements of the monitoring system within a storeroom 210. In this embodiment, a first RFID reader/antenna 220 and a second RFID reader/antenna 224 are mounted on a barrier 226 that is located adjacent an interior of a doorway 212 of the storeroom 210. The barrier 226 is configured to help prevent the first RFID reader/antenna 220 from interfering with the second RFID reader/antenna 224.

The first RFID reader/antenna 220 is positioned such that its detection field covers items moving through the doorway 212. The second RFID reader/antenna 224 is positioned such that its detection field is aimed 180 degrees away from the detection field of the first RFID reader/antenna 220, and thereby detects RFID tags that are located inside the storeroom, but adjacent the doorway 212. As a result, the detection fields of the first and second RFID readers/antennas 220/224 do not overlap. However, the operations of the first and second RFID readers/antennas 220/224 are otherwise quite similar to those of the first and second RFID readers/antennas 120/124 described above in connection with FIGS. 1A and 1B.

FIG. 3 depicts another alternate arrangement of the elements of the monitoring system within a storeroom 310. In this embodiment, a first RFID reader/antenna 320 and a second RFID reader/antenna 324 are mounted adjacent an interior of a doorway 312 of the storeroom 310. The first RFID reader/antenna 320 is mounted such that its detection field covers items moving through the doorway 312. Also, the first RFID reader/antenna 320 is positioned and mounted relative to the second RFID reader/antenna 324 such that the RFID readers/antennas 320/324 have detection fields that are oriented 90 degrees apart from one another. The detection strength of the first and second RFID readers/antennas 320/324 are also adjusted such that the detection areas are relatively short. These factors help to prevent any substantial overlap of the detection fields of the first and second RFID readers/antennas 320/324. However, the operations of the first and second RFID readers/antennas 320/324 are otherwise quite similar to those of the first and second RFID readers/antennas 120/124 described above in connection with FIGS. 1A and 1B.

In the embodiments depicted in FIGS. 2 and 3, the first and second RFID readers are located just inside the doorway into the storeroom. In alternate embodiments, the first and second RFID readers could be mounted substantially as depicted in FIGS. 2 and 3, but just outside the doorway into the storeroom.

Similarly, the first and second RFID readers could be positioned on the ceiling or in the floor, either inside or outside the doorway of the storeroom. For example, the first RFID reader could be positioned in the ceiling adjacent the doorway, with the detection field of the first RFID reader being aimed downward at an angle out of the storeroom. The second RFID reader could be positioned adjacent the first RFID reader in the ceiling with its detection field aimed downward at an angle into the storeroom. For example, there could be a 90 degree angle formed between the detection fields of the first and second RFID readers, similar to what is shown in FIG. 3, but with the detection fields being aimed downward from the ceiling rather than horizontally. This same concept would work with the first and second RFID readers being mounted in or on the floor, adjacent the doorway, with the detection fields being pointed upward at angles into and out of the storeroom.

The storeroom monitoring system may also include a third RFID reader (not shown in FIGS. 1-3) that is portable. The third portable RFID reader may detect one or more first RFID tags within the storeroom, and the processing system 130 may be further configured to update or add inventory records for items having RFID tags detected by the third RFID reader.

In alternate embodiments, the second RFID reader/antenna 124/224/324 located inside the storeroom could monitor for and detect RFID tags 162 of multiple items 160 within the storeroom or within a zone of the storeroom. Likewise, multiple additional RFID readers/antennas could be mounted at different locations inside the storeroom, with each respective RFID reader/antenna being responsible for detecting the RFID tags of items in different zone of the interior of the storeroom. The processing system 130 could be configured to cause the one or more RFID readers/antennas to periodically detect the RFID tags 162 of items 160 in their respective zones as a way of taking an inventory of items located within the storeroom.

This type of an inventory can be useful in determining when to order new supplies of consumable items. This type of inventory could also be used to periodically conduct audits of the inventory of the storeroom as a way of determining whether there have been errors in detecting movement of items into and out of the storeroom or of identifying theft.

A monitoring system as described may allow entities (e.g., businesses and government agencies) to eliminate significant manual work in monitoring a storeroom, as embodiments of the monitoring system can automatically perform actions such as preparing invoices and managing replenishment of items in the storeroom. The reduction in manual work can reduce traffic, reduce personnel needs, and eliminate human error in inventory management. Such an automatic monitoring system can provide a real-time analysis of item usage and inventory, and also detect usage patterns and replenishment needs. In addition, embodiments of the monitoring system permit tracking of how individual employees use certain items. Further, embodiments of monitoring system may also enable more accurate calculation of desirable minimum or maximum amounts of specific items.

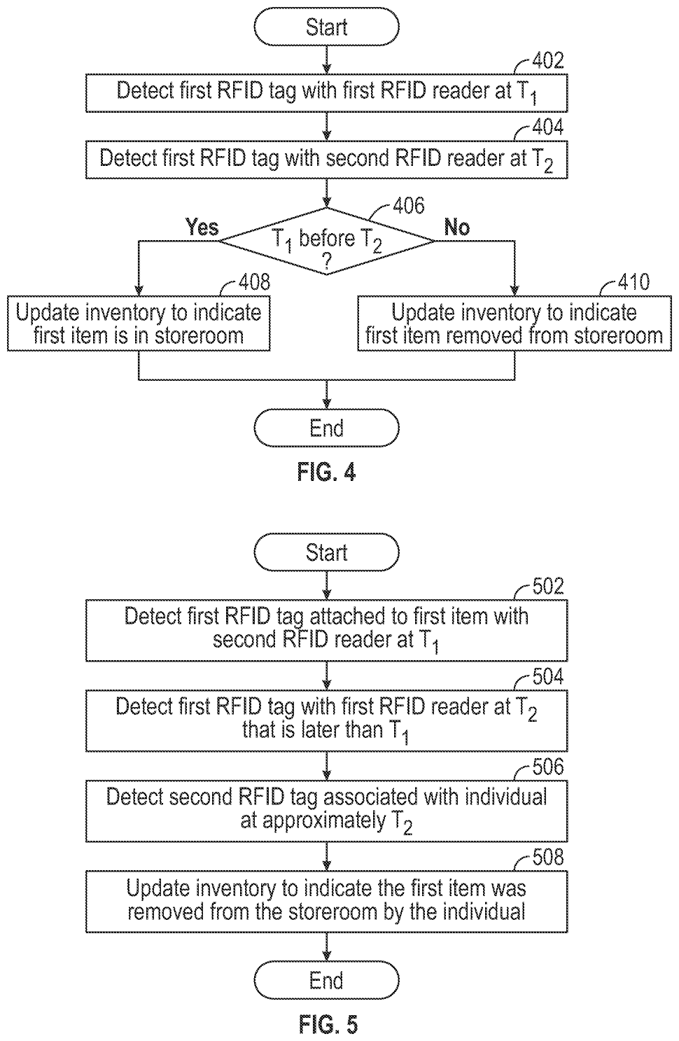

FIG. 4 depicts a flowchart of steps of a first method of updating an inventory of a storeroom. The method 400 begins and proceeds to step 402 where a first RFID reader/antenna 120 detects a first RFID tag 162 attached to a first item 160 at time T₁. Next, in step 404 a second RFID reader/antenna 124 detects the same first RFID 162 tag attached to the first item 160 at time T₂. Note, T₁ could occur before or after T₂. If the first RFID reader/antenna 120 detects the first RFID tag 162 before the second RFID reader/antenna 124 detects the first RFID tag 162, this would mean that the first item 160 is being brought into the storeroom. If the second RFID reader/antenna 124 detects the first RFID tag 162 before the first RFID reader/antenna 120 detects the RFID tag 162, this would mean that the first item 160 is being removed from the storeroom.

In step 406, the processing system 130 determines whether T₁ is before T₂. If so, indicating that the first item is being brought into the storeroom, then the method proceeds to step 408, and the processing system 130 instructs the inventory control system 180 to update the storeroom inventory to reflect the fact that the first item 160 is now located inside the storeroom. If the check perform in step 406 indicates that T₁ is not before T₂, indicating that the first item was removed from the storeroom, then the method proceeds to step 410 and the processing system 130 instructs the inventory control system 180 to update the storeroom inventory to indicate that the first item has been removed from the storeroom. The method then ends.

FIG. 5 depicts a second method of updating an inventory of a storeroom. In this method, an item is being removed from the storeroom, and information about the individual that removed the item from the storeroom is determined and recorded.

The method 500 begins and proceeds to step 502 where a second RFID reader/antenna 124 detects a first RFID tag 162 attached to a first item 160 at time T₁. Next, in step 504, a first RFID reader/antenna 120 detects the first RFID tag 162 at time T₂, where T₂ is later than T₁. Because T₂ is later than T₁, the first item 160 is being removed from the storeroom. In step 506, the first RFID reader/antenna 120 detects a second RFID tag 152 that is associated with an individual 150 at approximately time T₂. Because the first RFID reader/antenna 120 detected the second RFID tag 152 at approximately the same time (T₂) that the first RFID reader/antenna 120 detected the first RFID tag 162, we know that the individual 150 associated with the second RFID tag 152 is the individual that removed the first item 160 from the storeroom.

In step 508, the processing system 130 instructs the inventory control system 180 to update the inventory for the storeroom to indicate that the first individual 150 removed the first item 160 from the storeroom. The method then ends.

Step 506 of the method depicted in FIG. 5 could be replaced or augmented with a step in which the second RFID reader/antenna 124 detected the second RFID tag 152 associated with the first individual 150 at approximately time T₁. This too would provide an indication that the first individual 150 associated with the second RFID tag 152 is the individual removing the first item 160 from the storeroom.

In some embodiments, the processing system 130 may be configured to receive signals from the RFID readers indicating detection of both an RFID tag attached to an item and an RFID tag associated with an individual that occur at substantially the same time. If the processing system 130 receives signals from an RFID reader indicating detection of an RFID tag attached to an item, but no associated substantially concurrent detection of an RFID tag associated with an individual, the processing system could signal the alarm system 170 to sound or illuminate an alarm or to issue an electronic alert (such as by an email, a text message, a push notification etc.), as this could indicate that an unauthorized individual is improperly removing the item from the storeroom.

Similarly, the inventory control system 180 and/or the processing system 130 could track which individuals are authorized to remove and return individual items from the storeroom. If the processing system 130 receives signals from an RFID reader indicating that an individual is removing an item from the storeroom or replacing an item in the storeroom, and the individual is not authorized to handle the item, the processing system 130 could instruct the alarm system 170 to issue an alarm or to send an alert message.

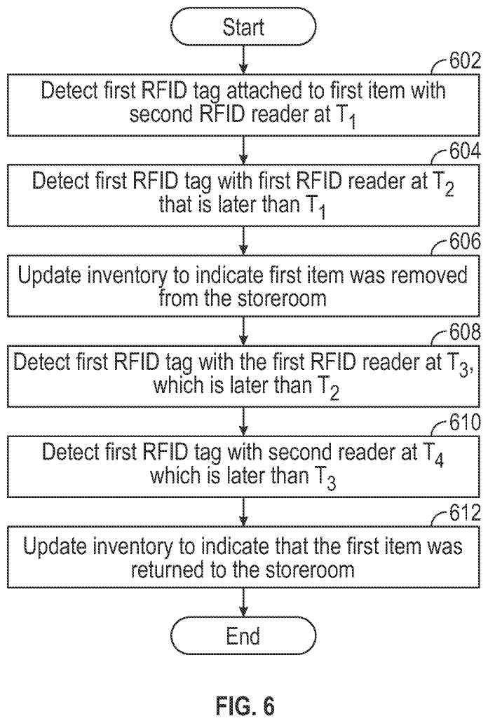

FIG. 6 depicts steps of another method of updating an inventory of a storeroom. In this method, the monitoring system tracks an item as it is removed from and returned to the storeroom.

The method 600 begins and proceeds to step 602 where a second RFID reader/antenna 124 detects a first RFID tag 162 attached to a first item at T₁. Next, in step 604, a first RFID reader/antenna 120 detects the first RFID tag 162 at time T₂, which is later than time T₁. This means the item 160 is being removed from the storeroom. As a result, in step 606, the processing system 130 instructs the inventory control system 180 to update the inventory for the storeroom to indicate that the first item 160 was removed from the storeroom.

In step 608 the first RFID reader/antenna 120 detects the first RFID tag 162 at time T₃, which is later than time T₂. Next, in step 610, the second RFID reader/antenna 124 detects the first RFID tag 162 at time T₄, which is later than time T₃. This indicates the first item 160 is being brought back into the storeroom. As a result, in step 612, the processing system 130 instructs the inventory control system 180 to update the inventory for the storeroom to indicate that the first item 160 has been returned to the storeroom. The method then ends.

In some embodiments, where the identity of each individual that moves an item out of or into the storeroom is tracked in addition to movement of the item itself, the processing system 130 may be configured to cause the alarm system 170 issue an alarm or to send an electronic alert if a first individual removes an item from the storeroom, but a second, different individual thereafter brings the same item back into the storeroom

The systems and methods described above may be implemented in and performed by hardware, software, or a combination thereof. In the context of software, the described operations represent computer-executable instructions stored on one or more computer-readable media that, when executed by one or more processors, perform the recited operations. Generally, computer-executable instructions include routines, programs, objects, components, data structures, and the like that perform particular functions or implement particular abstract data types.

The computer-readable media may include nontransitory computer-readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some implementations, the computer-readable media may include a transitory computer-readable signal (in compressed or uncompressed form). Examples of computer-readable signals, whether modulated using a carrier or not, include, but are not limited to, signals that a computer system hosting or running a computer program can be configured to access, including signals downloaded through the Internet or other networks. Finally, the order in which the operations are described is not intended to be construed as a limitation, and any number of the described operations can be combined in any order and/or in parallel to implement the process.

1. A method of tracking inventory in a storeroom, comprising:
detecting a first RFID tag attached to a first item at a first time with a first radio-frequency identification (RFID) reader/antenna that is configured to detect RFID tags located in a first zone relative to a doorway of a storeroom;
detecting the first RFID tag at a second time with a second RFID reader/antenna that is configured to detect RFID tags located in a second zone relative to the doorway of the storeroom, where the first zone is farther from an interior of the storeroom than the second zone;
updating an inventory of the storeroom to indicate that the first item is located in the storeroom if the first time is earlier than the second time; and
updating an inventory of the storeroom to indicate that the first item is not located in the storeroom if the second time is earlier than the first time.

2. The method of claim 1, wherein when the second time is earlier than the first time, the method further comprises:
detecting a second RFID tag associated with a first individual with the first RFID reader/antenna at approximately the first time or detecting the second RFID tag with the second RFID reader/antenna at approximately the second time; and
updating the inventory of the storeroom to indicate that the first individual removed the first item from the storeroom.

3. The method of claim 2, further comprising:
detecting the first RFID tag with the first RFID reader/antenna at a third time that is later than the first time;
detecting the first RFID tag with the second RFID reader/antenna at a fourth time that is later than the third time; and
updating the inventory of the storeroom to indicate that the first item has been returned to the storeroom.

4. The method of claim 3, further comprising updating the inventory to indicate that the first individual returned the first item to the storeroom when the first RFID reader/antenna detects the second RFID tag at approximately the third time or the second RFID reader/antenna detects the second RFID tag at approximately the fourth time.

5. The method of claim 1, wherein when the second time is earlier than the first time, and wherein when either the first RFID reader/antenna fails to detect a second RFID tag associated with an individual at approximately the first time or the second RFID reader/antenna fails to detect the second RFID tag at approximately the second time, the method further comprises issuing an alert indicating that the first item may have been improperly removed from the storeroom.

6. A system for monitoring an inventory of a storeroom, comprising:
a first radio-frequency identification (RFID) reader/antenna configured to detect RFID tags located in a first zone relative to a doorway of a storeroom;
a second RFID reader/antenna configured to detect RFID tags located in a second zone relative to the doorway of the storeroom, wherein the first zone is farther from an interior of the storeroom than the second zone; and
at least one processor configured to receive signals from the first RFID reader/antenna and the second RFID reader/antenna, wherein the at least one processor is configured to:
update an inventory of the storeroom to indicate that a first item bearing a first RFID tag is located in the storeroom when the first RFID reader/antenna detects the first RFID tag at a first time, the second RFID reader/antenna detects the first RFID tag at a second time, and the first time is earlier than the second time; and
update an inventory of the storeroom to indicate that the first item is not located in the storeroom when the first RFID reader/antenna detects the first RFID tag at a first time, the second RFID reader/antenna detects the first RFID tag at a second time, and the second time is earlier than the first time.

7. The system of claim 6, wherein the at least one processor is also configured to update the inventory of the storeroom to indicate that a first individual removed the first item from the storeroom when the first RFID reader/antenna detects the first RFID tag at a first time, the second RFID reader/antenna detects the first RFID tag at a second time, the second time is earlier than the first time and either the first RFID reader/antenna detects a second RFID tag associated with the first individual at approximately the first time or the second RFID reader/antenna detects the second RFID tag at approximately the second time.

8. The system of claim 7, wherein the at least one processor is also configured to update the inventory of the storeroom to indicate that the first item has been returned to the storeroom when the first RFID reader/antenna detects the first RFID tag at a third time that is later than the first time and the second RFID reader/antenna detects the first RFID tag at a fourth time that is later than the third time.

9. The system of claim 8, wherein the at least one processor is also configured to indicate that the first individual returned the first item to the storeroom when either the first RFID reader/antenna detects the second RFID tag at approximately the third time or the second RFID reader/antenna detects the second RFID tag at approximately the fourth time.

10. The system of claim 6, wherein the at least one processor is configured to cause an alert to be issued, the alert indicating that the first item may have been improperly removed from the storeroom, when the second time is earlier than the first time, and wherein when the first RFID reader/antenna fails to detect an RFID tag associated with an individual at approximately the first time.

11. The system of claim 6, wherein the first RFID reader/antenna is configured to be weather resistant.

12. The system of claim 6, further comprising an alarm system that is operatively coupled to the at least one processor and that is configured to generate an alarm signal and/or to cause alerts to be issued.
